(19) United States
(12) Patent Application Publication
(10) Pub. No.: US 2017/0116577 A1
(43) Pub. Date: Apr. 27, 2017

(54) METHOD AND SYSTEM FOR MANAGEMENT OF HUMAN RESOURCE SCHEDULING RULES AND PROGRAMS

(71) Applicants: Durga Prasad Vanamala, Minneapolis, MN (US); Alissa Mae Flynn, Minneapolis, MN (US); Randal Wane Hulke, Plymouth, MN (US)

(72) Inventors: Durga Prasad Vanamala, Minneapolis, MN (US); Alissa Mae Flynn, Minneapolis, MN (US); Randal Wane Hulke, Plymouth, MN (US)

(21) Appl. No.: 15/285,362

(22) Filed: Oct. 4, 2016

Related U.S. Application Data
(60) Provisional application No. 62/245,408, filed on Oct. 23, 2015.

(51) Int. Cl. G06Q 10/10; G06F 3/0484

(52) U.S. Cl. CPC G06Q 10/1057; G06F 3/04847

(57) ABSTRACT

Embodiments of a system and method for managing employee paid time off or other human resource scheduling according to rules and programs in a graphical user interface are generally described herein. Embodiment may also describe associations between the rules and programs. In further embodiments, employee accruals may be determined based on the rules or programs.

### PRIORITY CLAIM

This application claims the priority benefit of U.S. Provisional Application Ser. No. 62/245,408, filed Oct. 23, 2015, which is hereby incorporated by reference in its entirety.

### BACKGROUND

Modern companies often conduct business in multiple states and have employees located around the country. For large corporations having employees across different states, determining accruals for paid time off, sick time, and flex time is often difficult. Additionally, certain states and cities have varying requirements that may trump accruals for employee plans and must be administered according to law. Other issues arise with determining and assigning accruals for part time employees, consultants, salaried employees, hourly employees, and other employee classifications. Current solutions take an ad hoc approach that is time consuming and error prone.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a simplified process flowchart of a method that eliminates coding, testing, and review, according to one example.

FIGS. 2A and 2B illustrate a human resources scheduling program rules information screenshot and a human resources scheduling program rules criteria screenshot, according to one example.

FIG. 3 illustrates a program balance actions screenshot including a program balance actions tab, according to one example.

FIG. 4 illustrates a plan assignment screenshot including plan assignment codes, according to one example.

FIG. 5 illustrates a plan type screenshot showing different types of plans and their meanings, according to another example.

FIG. 6 illustrates a plan comparison screenshot including types of comparison operations, according to one example.

FIG. 7 illustrates a plan fields screenshot including fields such as assignment category. Fair Labor Standards Act (FLSA) (e.g., exempt/non-exempt), GRE name, home city, home county, home state, etc., according to one example.

FIG. 8 illustrates a human resources scheduling timings screenshot showing grant time ongoing and grant timing newly eligible categories including relevant date categories, according to one example.

FIG. 9 illustrates a process overview flowchart showing PTO rules and processing for determining PTO for an employee, according to one example.

FIG. 10 illustrates a PTO eligibility flowchart showing a technique for determining an employee PTO grant plan, according to one example.

FIG. 11 illustrates a vacation program eligibility flowchart including operations for determining eligibility if an employee works or lives in certain specified states that have their own requirements, according to one example.

FIG. 12 illustrates an absence eligibility flowchart according to one example.

FIG. 13 illustrates an overall flowchart for determining employee eligibility for special sick plans, according to one example.

FIG. 14 illustrates a flowchart showing a technique for determining if an employee qualifies for eligibility under Puerto Rico laws, according to one example.

FIG. 15 illustrates generally an example of a block diagram of a machine upon which any one or more of the techniques discussed herein may perform in accordance with some embodiments.

### DETAILED DESCRIPTION

Administering a Paid Time Off (PTO). Vacation, Sick leave, Family leave, or other human resources scheduling programs at a company that has offices or employees in multiple states is often time consuming and challenging. Changes to human resources (HR) software to implement specific PTO or sick leave rules may require software development, extensive testing, and compliance oversight. The present disclosure includes methods and systems that allow the up-front addition of eligibility rules and input of entrance/exit criteria to allay the issues found in existing systems. These methods and systems may also minimize the technical effort and testing for future changes.

In one example, a series of definitions are created for various eligibility rules, plan entry/exit criteria, and grant/accrual rates (and associated plan configurations) for each category or type of human resource scheduling. These definitions control the plans that a particular employee is eligible for, and how to transition to (or from) a different plan. These definitions may be input by a Functional Analyst, rather than a programmer, thus minimizing the technical and testing efforts for “code” changes that are required by existing solutions. In a specific example, these definitions may be created through the use of Oracle E-Business (EBS) forms, although integration with any number of business application platforms may be accomplished.

In a further example, the rule definition entry forms are supplemented with a rules “back-end” engine that is configured to interpret the rules and rates entered to determine plan eligibility, to compute an amount of time-off disbursement (grants/accruals) for various employees, and to update payroll data. Additionally, as described herein, the rules back-end engine can be invoked from the entry forms to perform a simulation of the results of the entered plan configuration. This provides the ability to identify affected employees and to avoid large regression test efforts, while further reducing the amount of time needed for plan changes.

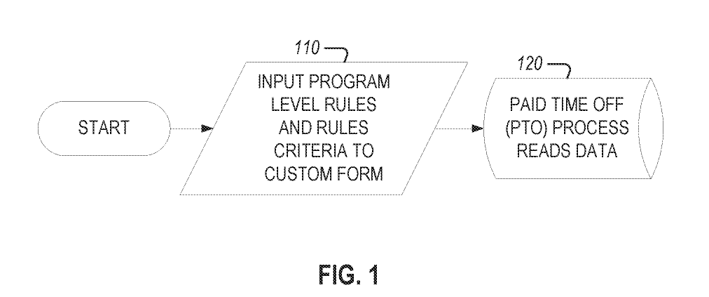

FIG. 1 illustrates a simplified process flowchart of a method that eliminates coding, testing, and review, according to one example. The method of the depicted flowchart includes receiving an input of program level rules and rules criteria on a custom form at operation 110, and processing the data at operation 120 with a processing component (a “PTO Processor”), such as the PTO definition, simulation, and evaluation process implemented by the computer systems and software configurations described below. As discussed herein, the applicability of the PTO definition, simulation, and evaluation process extends to any number of HR scheduling types including PTO, vacation, absence, and state/city sick policies.

Complicating factors involved in the creation of HR scheduling rules includes having to adhere to the different state/city paid time off laws of each jurisdiction, and the offerings of paid time off plans that are defined for a variety of enrolled employees and employee levels. In existing PTO tracking systems, eligibility rules and grant/accrual rates (e.g., plan configurations) are hardcoded within the PTO tracking system. Even small changes require the entire PTO calculation process to be thoroughly tested, which takes significant amount of time and resources. The presently disclosed techniques and PTO scheduling procedures offer a simplified method of defining, handling, and processing paid-time off rules that can integrate with a payroll system. Additionally, because there are “exceptions” to the rules, an override process is definable to specifically dictate which plan that an employee will belong to.

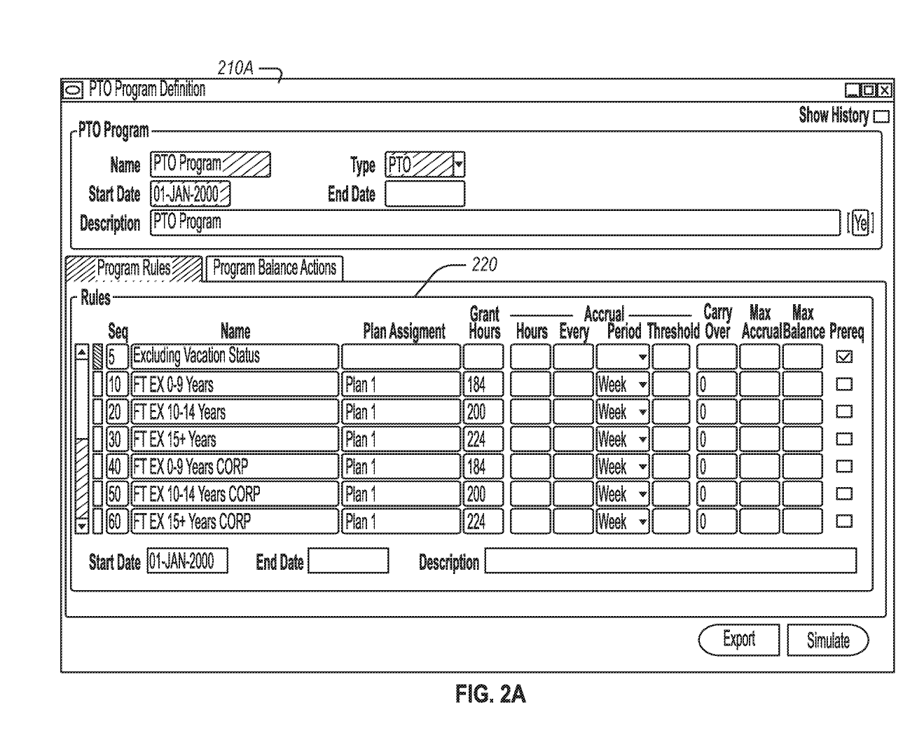

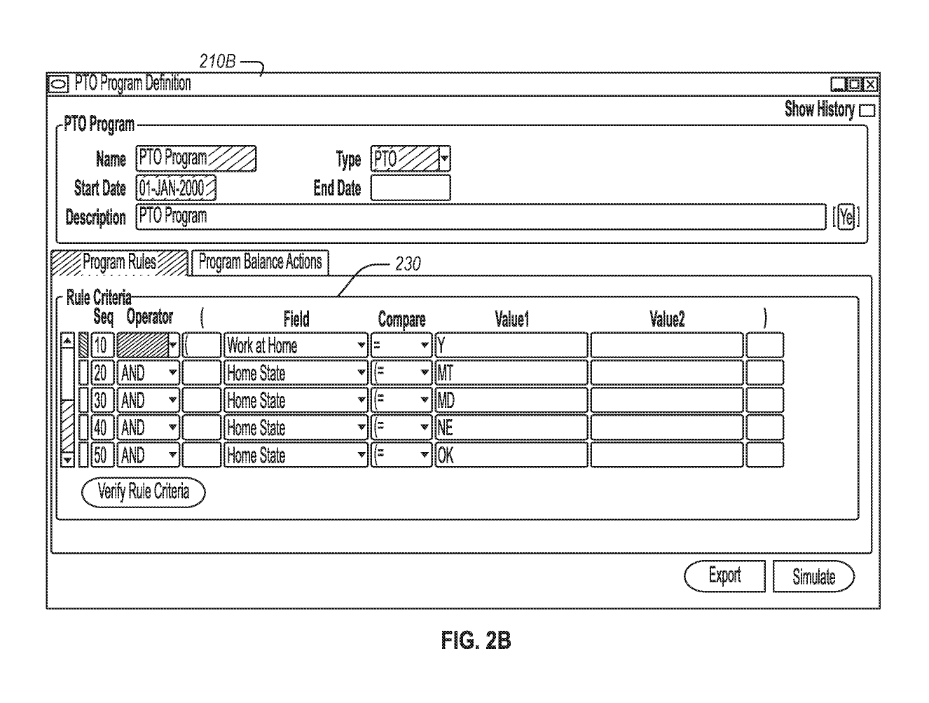

FIGS. 2A and 2B illustrate a human resources scheduling program rules information screenshot 210A and a human resources scheduling program rules criteria screenshot 210B, according to one example, for a definition which may be applied for one or more of paid time off, vacation, absence, and state/city sick policies. FIG. 2A includes the following input fields, which may be used for defining a program in a human resources scheduling rule processing computer system.

Name: This is the name of the program. It defines the rules below that are used within the program. Below are 12 separate example programs:
Absence Program—includes employees eligible for the standard Absence Program;
California City Sick Program—PT or OS eligible employees who live/work in select cities in California;
California State Sick Program—PT or OS eligible employees who live/work in the state California (and are not a part of the California City Sick Program);
New Jersey City/State Sick Program—eligible employees who work/live in New Jersey or Cities within New Jersey;
New York City/State Sick Program—eligible employees who work/live in New York City or one of its Boroughs;
Other City/State Sick Program—eligible employees in other city/states who have a sick plan;
Override City/State Sick Program—eligible employees who work in specific locations which are assignment to a specific City/State Sick plan;
PTO Program—includes those employees eligible to receive an annual grant of time off, who are not in CA, DC, OK, MD, MT, NE or PR;
Puerto Rico Sick Leave Program—includes those employees who live/work in Puerto Rico;
Puerto Rico Vacation Program—includes those employees who live/work in Puerto Rico;
Vacation Accrual Program (FT)—FT eligible employees in CA, DC, OK, MD, MT or NE who receive a Vacation Accrual each week;
Vacation Accrual Program (PT/OS)—PT or OS eligible employees in CA who receive a Vacation Accrual each week.

Plan Type: What type of a plan is this, valid values include PTO, Vacation. Absence. This field drives which Element Entries may be updated as a result of the employees' eligibility. This field also may define which PTO Extra Information Type (EIT) Plan Title field to use (e.g., Time Off Plan or Absence Plan).

Start Date—the start date of this program. Used to signify when this program started. End Date—the end date of this program. Used to signify if this program is ended, or still in use. If populated, this program is no longer in use. If blank, program is active as of the date.

Description—a description of this program (can be different for each Rule).

Rules listing 220: The Rules listing 220 is used to establish human resources scheduling definitions in the program, to define what amount of PTONacation/Absence Accrual an employee is eligible for. An overview of the various definition fields in the Rules listing 220 are described below.
Seq: 10, 20, 30, etc.—this is the order in which Rules will display.
Name: Descriptive Name of Rule. Should include enough information to allow users to understand what employees are covered by rule (at a high level). The value in this field will be passed to the ‘Threshold’ field on the Accrual elements.
Plan Assignment: This field drives what plan is sent to the PTO Extra Information Type (EIT). The EIT is used to send information to downstream applications or other organizational departments. This field may be attached to a lookup table.
Grant Hours: Amount of PTO, Vacation or Absence to be granted for eligible employee.
Accrual: Amount of Vacation or Absence time to be accrued for an eligible employee. Defined with: Hours—How many hours to accrue (may be in tenths, hundredths, etc.); Every—How often accrual will happen (e.g., 0, 1, 2 etc.); Period—What the period of the accrual is—Hour, Day, Week, Month, Quarter, Year, etc.; Threshold—The amount of hours the employee must work prior to receiving any accrual.
Carryover: Amount of time that can be carried over to next term per plan rules—for example, carry over may occur based on a calendar year and the actual date is determined by a payroll calendar. This field may be left blank if there is no carryover rule for the processor to review, or populated with a positive number. Populating a ‘0’ in this field causes the processor to clear out a balance at the end of a calendar year.
Max Accrual: Maximum amount allowed to be accrued before “capping out” annually—no further accruals will take place when this amount is reached. For purposes of this field, ‘annually’ may be January 1^{st}-December 31^{st} or a fiscal year. Max Balance: Maximum balance that this plan can have at any time.
Prereq (checkbox): When checked, the program assumes that this rule is a prerequisite to all additional rules. When using this checkbox, this rule may have a lower sequence number than the rules it applies to.

Modifying Rules: To add a new rule, a cursor is placed on a row above where the rule should be inserted and an add button is clicked. A sequence number between the previous rule and next rule is selected. New criteria may be entered and the ‘Save’ button may be clicked. At least one Rule Criteria 230 below for each new rule may be added. The ‘Simulate’ button may be used to determine how this rule will impact a given population. A new rule may be added anywhere within the list, and the sort is based on the sequence number. Once the program is exited and reopened, the rules may sort ascending by sequence number.

To delete a rule, a cursor is placed on a row that should be deleted and a delete button is selected. The save button may be clicked to save. In an example. Rule Criteria must be deleted and saved before a Rule can be deleted. The ‘Simulate’ button may be used to determine how removing this rule will impact a given population. Instead of deleting a rule, rules can be end-dated via the ‘End Date’ field to stop their use going forward, but retain the rule for accounting or posterity purposes.

FIG. 2B includes the following input fields, which may be used for defining a program in a PTO rule processing computer system.

Rules Criteria listing 230: The Rules Criteria listing 230 provides an input of data to determine who is eligible for the rule. Each rule may have different criteria. An overview of the various definition fields in the Rules Criteria listing 230 are described below:
Seq: the order in which the criteria are processed (10, 20, 30 etc.).
Operator: each criteria can be added to (AND), or used instead of (OR).
“(”—this field allows an open parenthesis to be added if the statement has more than one ‘or’ criteria; “)”—this field allows a close parenthesis to be added if the statement has more than one ‘or’ criteria. Note: Every ‘OR’ must have ‘( )’.
Field: determines the field being used in the criteria. Examples of the Field Rules Criteria 230 include: Assignment Category, FLSA, GRE name, Home City, Home State, Home County, Home Zip Code, Work City, Work location code, Work State, Work County, Work at Home, Work Zip code, Years of Service, or the like. Years of Service may be calculated based on the most recent fulltime anniversary date. In an example, for Years of Service, if an employee is part-time or occasional seasonal, the Latest Hire Date may be used.
Compare: determines how the ‘Field’ will be used with the ‘Value’. Comparison types may include !=Not equal to; <Less than; <=Less than or equal to; >Greater than; >=Greater than or equal to; Between (e.g., operator selects values within a range), or the like. The values for “Between” may be numbers, text, or dates and may be selected from values that are between and including a first and last value, or may exclude a first value but include a last value, include a first value but exclude a last value, or may exclude a first and last value. The first value may include is the value for the ‘Field’ above, and the first value may change depending on the ‘Field’ chosen. Valid values are determined based on the corresponding field in HR. The last value may include the next value in the string.

Verify Rule Criteria (button): When all rules and criteria are entered, the Verify Rule Criteria button may be selected to ensure the syntax is properly formed.

In a further example, specialized human resources scheduling program settings may be defined in the graphical user interface. Such specialized settings may be defined based on whether the defined program uses proration, as well as when to grant/accrue time for the defined program. For example, the following specialized fields may be defined:
Proration Considered—Yes/No—determines if a program is eligible for proration. If set to ‘Yes’, the human resource scheduling component (e.g., PTO Processor) prorates the grant amount when an employee is found eligible for this outside of the normal timing (i.e. Transfers).
Grant Timing Ongoing: On an annual or ‘ongoing’ basis, the human resources scheduling component will grant hours as of the value in this field (i.e. FT Anniversary date)—e.g., PTO grant will occur annually on the FT Anniversary date of the employee. Valid Values may include days since hire date, relevant pay periods, an anniversary date, or a hire date.
Grant Timing Newly Eligible: When employee becomes ‘newly’ eligible for this program (i.e. New Hire, Rehire. Move to FT) this will tell the human resources scheduling component when grant hours are given.
Accrual Timing Newly Eligible: When employee becomes ‘newly’ eligible for this program (i.e. New Hire, Move to FT) this will tell the human resources scheduling component when accrual begins.
Puerto Rico Only: This field tells the human resources scheduling component to select this program separately due to special processing rules. This should be left blank unless it is a Puerto Rico Program (Vacation or Sick Leave).

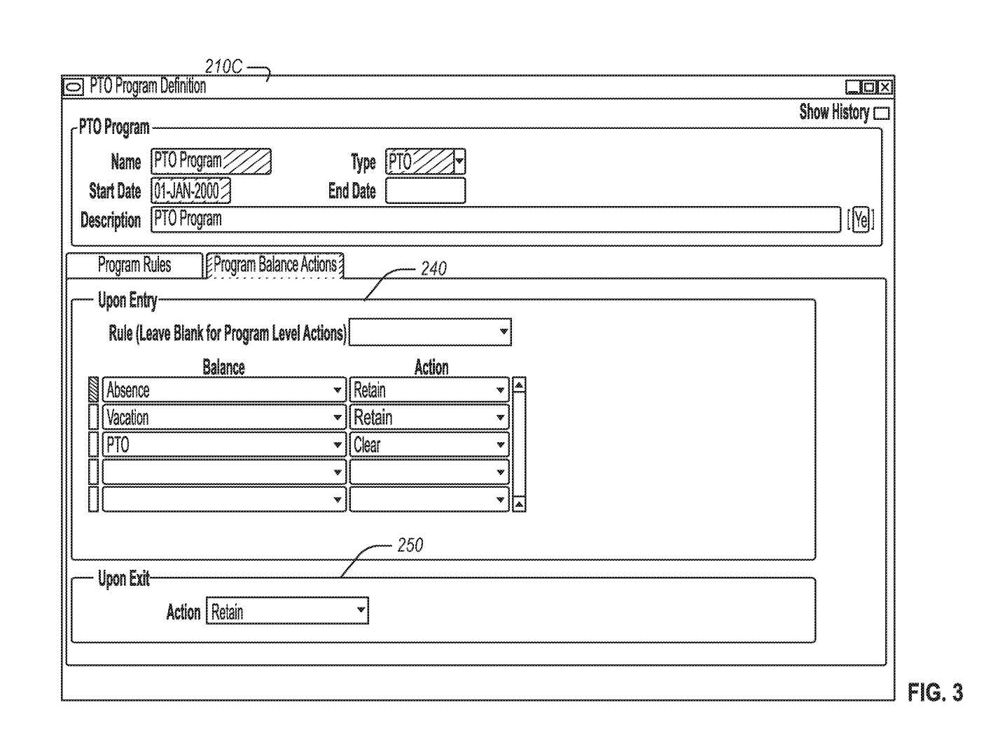

FIG. 3 illustrates a program balance actions screenshot 210C including a program balance actions tab, according to one example. FIG. 3 includes the following fields, which may be used for defining program balance actions in a human resources scheduling system.

Upon Entry Rules Field 240: Rule (leave blank for program level actions)—this field drives an Entry criteria into the program. If populated, the below criteria will apply only to that rule. If left blank, the below criteria applies to entire program. When looking at the list of values, an * may indicate there is a rule level action that exists for that specific rule; the criteria for a specific rule can be viewed by selecting it from the Rule list of values.

Balance: designates which plan type the program will evaluate with this rule. Action: tells program what to do with the balance for this plan type (above).

Upon Exit Rule Field 250: Includes Action: Retain or Clear—defines what should happen to the balance when an employee is found not eligible for the program. In one example, these rules are not used for termination. The termination rules are handled within the payout elements and Payroll.

As one example, the following rules shown in Table 1, illustrating program entrance and exit logic, may be defined to process PTO, Vacation, Absence, City/State Sick policies, and special vacation policies (e.g., Puerto Rico vacation policies):

TABLE 1

| | | | | | Puerto |
|---|---|---|---|---|---|
| | | | | City/State | Rico |
| | PTO | Vacation | Absence | Sick | Vacation |
| Entrance | If PTO | If PTO | If | If Absence | If PTO |
| Criteria: | balance | balance | Absence | balance | balance |
| Balance | exists | exists | balance | exists and | exists |
| | | | exists | CA State | |
| | | | | (not other | |
| | | | | CA City | |
| | | | | plans) Part | |
| | | | | Time/OS; | |
| | | | | No action | |
| | | | | for other | |
| | | | | balances | |
| | > Clear | > Transfer | > Clear | > Clear | > Clear |
| | | to | | | |
| | | Vacation | | | |
| | | balance | | | |
| | No action | No action | No | > Else, | No action |
| | for other | for other | action | Retain | for other |
| | balances | balances | for other | | balances |
| | | | balances | | |
| Entrance | If FT | Begin | Full | Full Grant | Begin |
| Criteria: | Anniversary | accruing | Grant | or Begin | accruing |
| Grant/ | > Full Grant | based on | | accruing | based on |
| Accrual | If not FT | rule | | based on | rule |
| | Anniversary | | | rule | |
| | > Prorated | | | | |
| | Grant | | | | |
| Exit | Retain | Retain | Retain | Retain | Retain |
| Criteria: | Balance | Balance | balance | Balance | Balance |
| Balance | | | | | |

Returning to FIGS. 2A and 2B, the definitions of the rules may be either exported with an export function, or simulated with a simulate function. The Program Export Functionality (e.g., invoked by the “Export” button depicted in FIGS. 2A and 2B) allows the current program setup to be exported to view all Rules and Criteria. The output is exportable and printable. The Simulation Functionality (e.g., invoked by the “Simulate” button depicted in FIGS. 2A and 2B) allows a user to ‘simulate’ what the human resources scheduling component (e.g., PTO Processor) will return for eligibility and accruals/grants. Data is temporarily written to temporary (e.g., staging) tables to build the simulation report and then deleted from the tables once the report is complete. Valid Parameters include those described below.

Simulation: Yes/No—when running from the Rules form this will default to ‘Yes’. If scheduling via other mechanisms, the default will be ‘No’. If set to No, only Run Frequency. Run Date. Run Phase and Number of Threads parameters become available (all others are made read only). Run Frequency, e.g., Daily, Weekly, Monthly, Run Date (may default to today's date), Run Phase: When selecting a phase it is incremental, for example if 30 is selected, phases 10, 20 and 30 are processed. This allows testing to be run in incremental steps. For example, phase 10 may include staging (i.e., populates list of employees to be evaluated regardless of eligibility), phase 20 may include qualify (i.e., generates program/rule eligibility for employees), phase 30 may include accrual (i.e., generates accrual and grant amounts to be given to employees), and phase 40 may include posting (i.e., creates ‘Accrued’ and ‘Adjustment’ element entries for employees). Number of Threads: This allows program to run multiple parallel workers/child processes; in an example, the default is 16. A higher number allows a program to run faster. Other valid parameters include: From Employee Number; To Employee Number; Assignment Category; FLSA; Work Location Code; City (Home or Work); State (Home or Work); Years of Service From; Years of Service To; Run Date (e.g., defaults to today's date).

Once the parameters are chosen for the employee population to be tested, the ‘ok’ button may be selected, causing a pop-up window to be displayed noting the Request ID that was generated to run the human resources scheduling component in simulation mode. Selecting the View>Requests and clicking the ‘View Output’ button allows all employees eligible for the parameters selected to be displayed. The output includes the results of the simulation, such as: Employee#. Employee Name, Eligible Program, Eligible Rule, Eligible Plan Type, Grant Amount, Accrual Amount, Carryover, Max Accrual, Max Balance. Summary data may be displayed at the top including Employees Staged (total population of employees). Employees Eligible (count of employees found eligible for a rule), PTO Accruals Success (should equal the Employees Eligible count and the row count on the report unless errors), PTO Accruals Failure (count of errors). PTO Accruals Unprocessed (count of accrual entries).

When the process is complete, an error may be displayed for any employees eligible for more than one rule within a Plan Type and employees eligible for more than one program (e.g., PTO Program and Vacation Program). The output may be saved as a text file and may be imported into a spreadsheet program to analyze, sort, filter, etc. the data.

As a result of the simulation, a listing of how rule changes would (or would not) affect individual employees or contractors working at a particular location, having a particular working status, or associated other known employment characteristics can be generated. Accordingly, if the simulation indicates an improper result, the rule can be modified before being implemented.

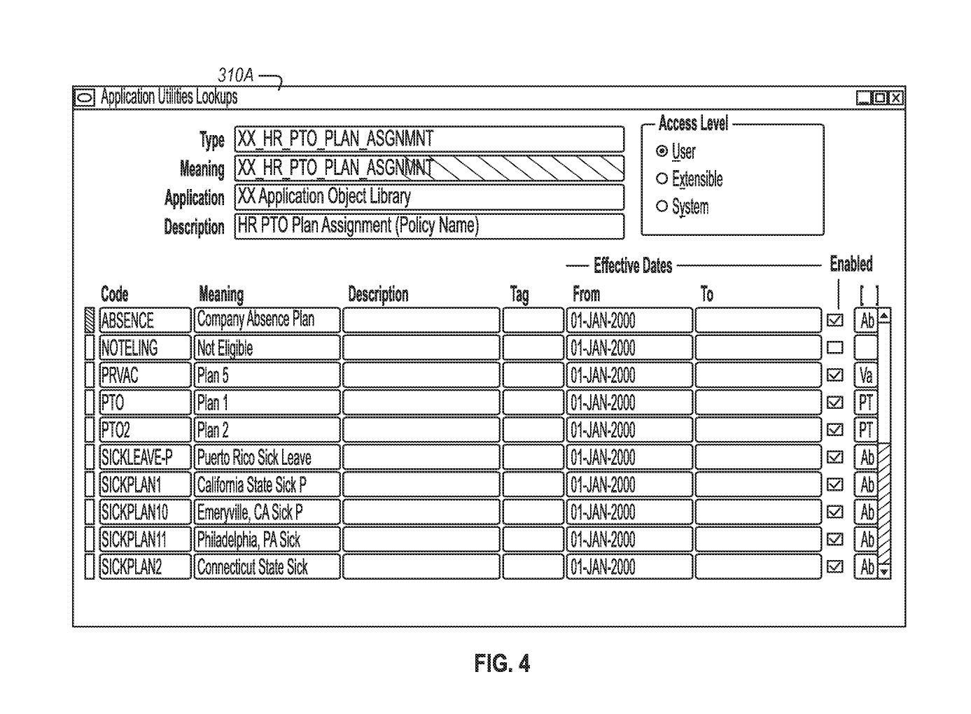

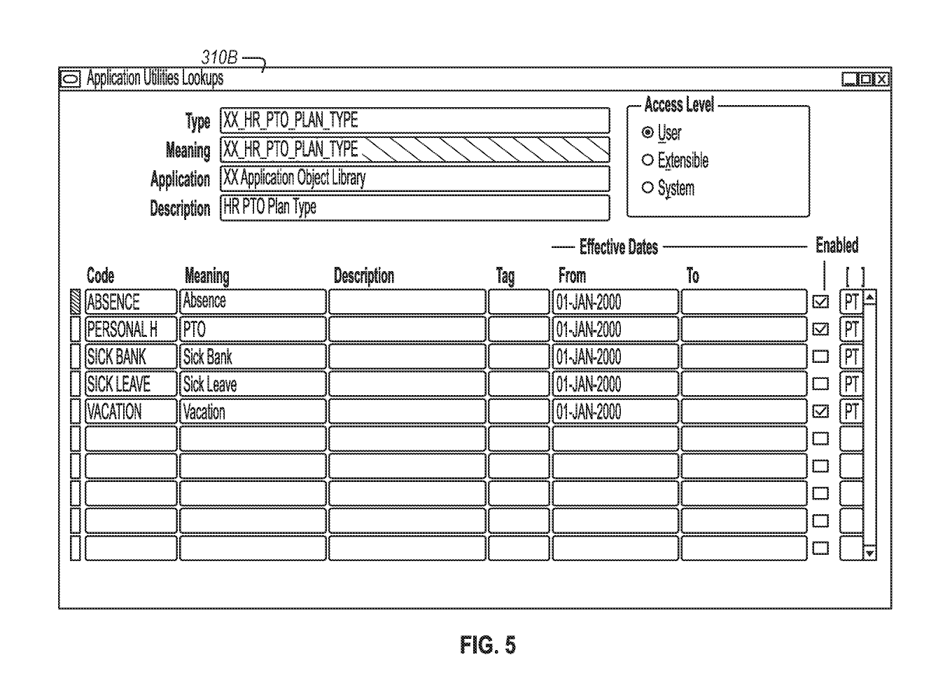

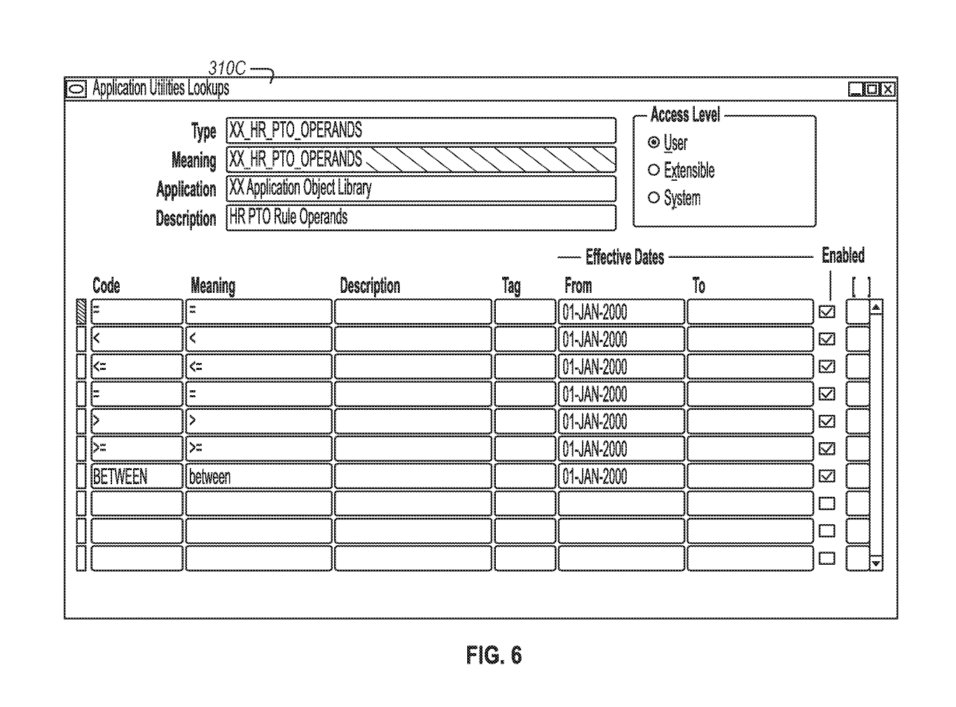

In further examples, the graphical user interface can be used to define other types of characteristics for a human resources plan. FIG. 4 illustrates a plan assignment screenshot 310A including plan assignment codes, according to one example. FIG. 5 illustrates a plan type screenshot 310B showing different types of plans and their meanings, according to another example. FIG. 6 illustrates a plan comparison screenshot 310C including types of comparison operations, according to one example.

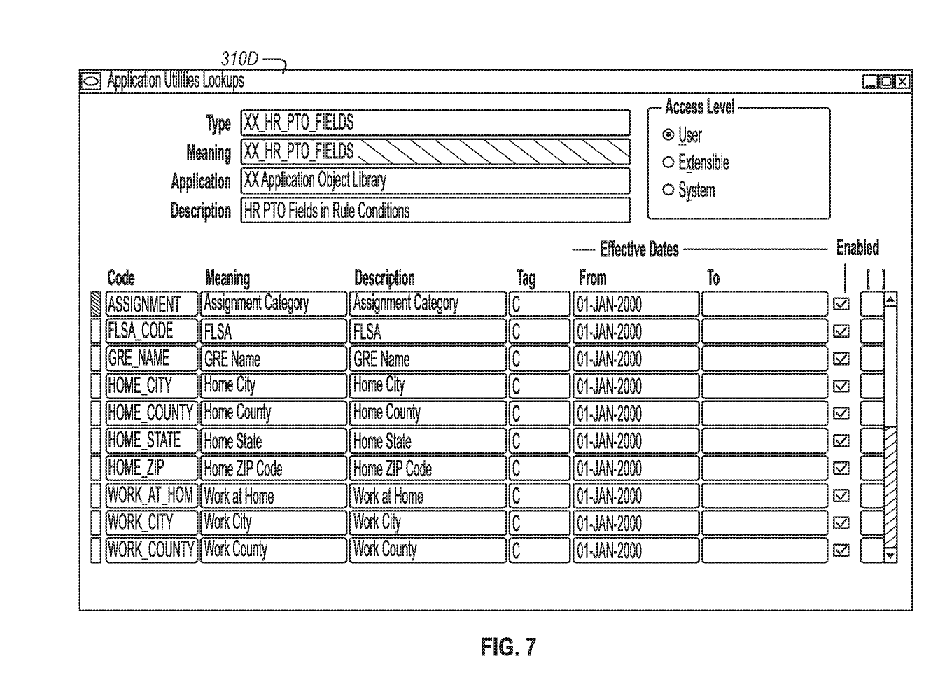

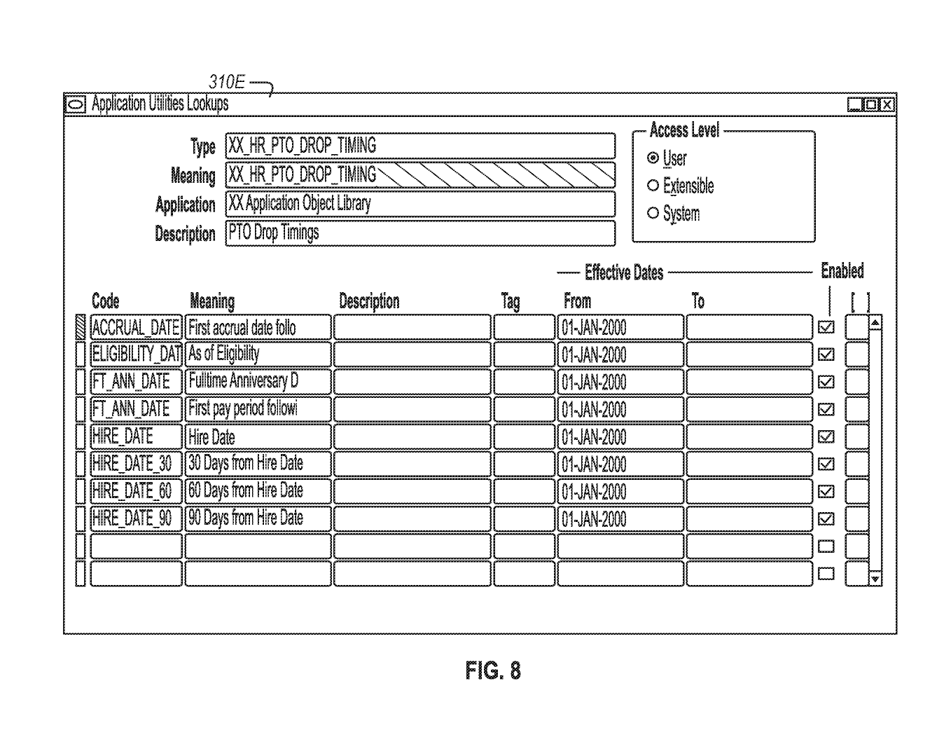

FIG. 7 illustrates a plan fields screenshot 310D including fields such as assignment category. Fair Labor Standards Act (FLSA) (e.g., exempt/non-exempt), GRE name, home city, home county, home state, etc., according to one example. FIG. 8 illustrates a PTO timings screenshot 310E showing grant time ongoing and grant timing newly eligible categories including relevant date categories, according to one example.

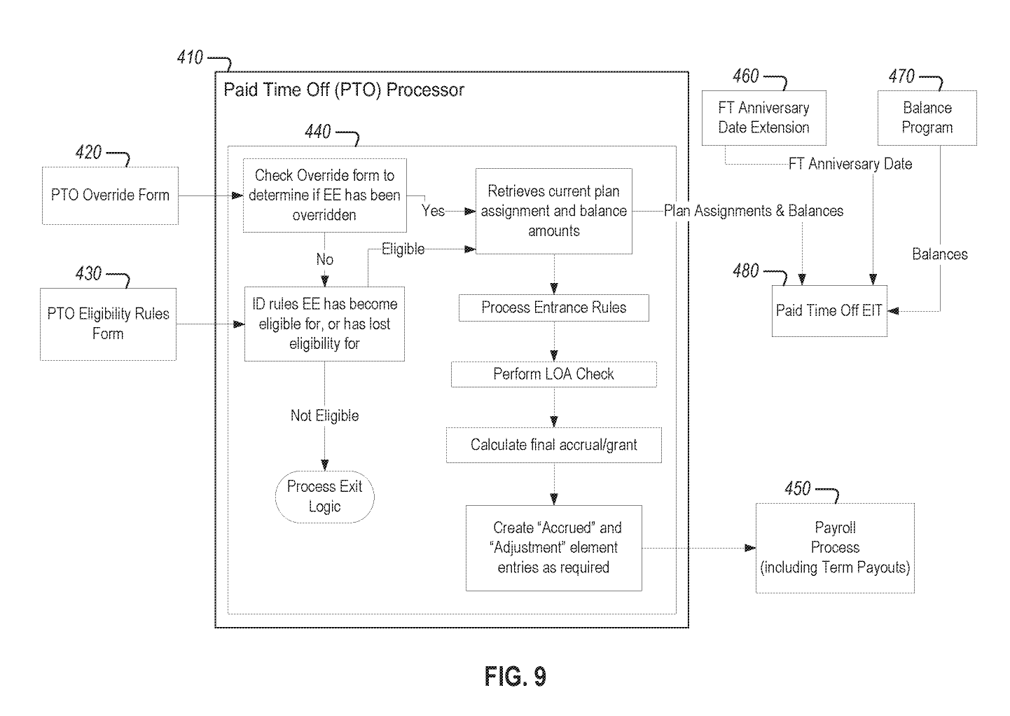

FIG. 9 illustrates a process overview flowchart showing rules and processing for determining PTO for an employee, according to one example. The output of the processing depicted in FIG. 9 may include a generation of payroll rules, plan assignments and balances, and like outputs.

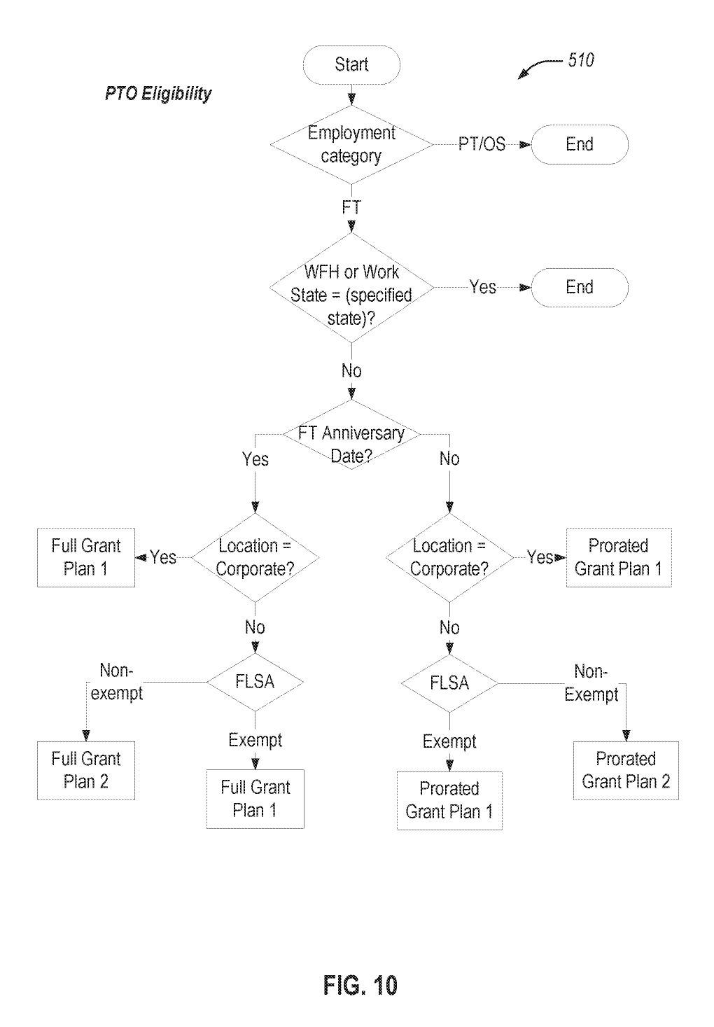

As a result of the flowchart in FIG. 9, various plans for non-exempt, exempt, full-time, pro-rated, and location-varying employees can be generated and integrated into payroll and other human resource processing systems (e.g., with payroll processing 450). Examples of the processing operations for the defined PTO and other human resources scheduling rules are further depicted in the flowcharts of FIGS. 10-14. As shown in the examples of FIGS. 10-14, the PTO Processor 410 considers whether the employee works from home or an office, where the home or office is located, and specific rules and characteristics for states, cities, and the like.

Returning to FIG. 9, the PTO Processor 410 may run with Daily, Weekly and Monthly parameters using separate logic per execution 440, based on input from a PTO Eligibility rule set (e.g., entered with a PTO Eligibility Rules form 430). The weekly accrual process may handle the following functions: weekly accruals for vacation, (accruals may be scheduled to occur on Mondays), weekly accruals for City/State Sick plans (Accruals may be scheduled to occur on Mondays), Max Balance (if max balance is reached, no further accruals occur), Max Accrual (if max accrual has been reached, no further accruals occur). Carryover (e.g., annually during the week that contains December 31st). For a carryover, if the balance is greater than carryover allowed, a negative adjustment element entry may be made to set balance back to the carryover amount. The carryover amounts by plan may be found in the Rules Configuration form.

The daily process may handle the following functions: process New Hire/Rehire Grants/Newly Eligible Grants (newly eligible grants may be received on eligibility date, such as with no waiting period), process On-going Grants (on-going grants may be received on the Monday of the pay period following the employee's Full Time Anniversary date), and process all entrance and exit criteria (if employee is found eligible or ineligible for a plan, this may review “balance logic” in Rules configuration form to determine how to process balances).

The monthly process may handle the following functions: Monthly Accrual for Puerto Rico employees, Max Balance—PR only (if max balance is reached, no further accruals occur), Max Accrual—PR only (if max accrual has been reached, no further accruals occur), Carryover—PR only (annually during the week that contains December 31 st). For a carryover, if the balance is greater than carryover allowed, a negative adjustment element entry may be made to set balance back to the carryover amount. Carryover amounts by plan may be found in the PTO Rules Configuration form.

In a further example, additional processing may be performed based on accrual timing and carryover characteristics. Grant/Accrual Timing includes Date Reference Points that may vary for the grant date or the accrual date including a Hire/Rehire Date, an Anniversary Date, and an Eligibility Date (e.g., the first day program finds employee eligible for a rule). Max Carryover may use the PTO Processor 410 to invoke Carryover (as defined on a PTO Rules form) logic. If Balance is less than limit, the PTO processor 410 may do nothing and if Balance is more than Max carryover limit, the PTO Processor 410 may create the PTO_Vacation_Adjustment element with a negative amount and a reason of ‘ACCRUED’ to lower balance to the Carryover Limit per the plan rule.

Leave of Absence—the PTO Processor 410 may account for a leave of absence when determining accruals, relevant dates, timing, balances, carryover, etc. Table 2, below, includes example leave of absence codes, reasons, descriptions, and applicable groups, for respective leave of absence conditions. For example, the Family and Medical Leave Act (FMLA) is a Federal law requiring employers to allow employees to take leave under certain circumstances. Similarly, some state laws, military regulations, and jury duty require leave to be grated to employees under certain circumstances. Accordingly, the following codings may be evaluated by the PTO Processor 410:

TABLE 2

| | | | | PTO | Vac | | |
|---|---|---|---|---|---|---|---|
| Code | Meaning | Description | From | Group | Wks | PH Wks | Abs Wks |
| 51E | FMLA- | FMLA- | 1-Jan-21 | no | no | no | no |
| | Reduce | Reduce | | limit | limit | limit | limit |
| | Schedule | Schedule | | | | | |
| 51H | FMLA-Work | FMLA-Work | 1-Jan-21 | no | no | no | no |
| | Comp | Comp | | limit | limit | limit | limit |
| | Intermittent | Intermittent | | | | | |
| 51I | FMLA- | FMLA- | 1-Jan-21 | no | no | no | no |
| | Intermittent/ | Intermittent/ | | limit | limit | limit | limit |
| | Reduced | Reduced | | | | | |
| | Schedule | Schedule | | | | | |
| | Family Care | Family Care | | | | | |
| 51J | FMLA- | FMLA- | 1-Jan-21 | no | no | no | no |
| | Reduced | Reduced | | limit | limit | limit | limit |
| | Schedule- | Schedule- | | | | | |
| | Military | Military | | | | | |
| | Family Care | Family Care | | | | | |
| 51K | FMLA- | FMLA- | 1-Jan-21 | no | no | no | no |
| | Reduced | Reduced | | limit | limit | limit | limit |
| | Schedule- | Schedule- | | | | | |
| | Qualifying | Qualifying | | | | | |
| | Exigency | Exigency | | | | | |
| 52M | NON | NON | 1-Jan-21 | no | no | no | no |
| | FMLA-Work | FMLA-Work | | limit | limit | limit | limit |
| | Comp | Comp | | | | | |
| | Reduced | Reduced | | | | | |
| | Schedule | Schedule | | | | | |
| 52N | NON | NON | 1-Jan-21 | no | no | no | no |
| | FMLA- | FMLA- | | limit | limit | limit | limit |
| | Medical | Medical | | | | | |
| | Reduced | Reduced | | | | | |
| | Schedule | Schedule | | | | | |
| 52F | LOA-Jury | LOA-Jury | 1-Jan-21 | no | no | no | no |
| | Duty | Duty | | limit | limit | limit | limit |
| 52P | LOA- | LOA- | 1-Jan-21 | no | no | no | no |
| | Military <30 | Military <30 | | limit | limit | limit | limit |
| | days | days | | | | | |
| 52O | LOA- | LOA- | 1-Jan-21 | no | no | no | no |
| | Military/RO | Military/RO | | limit | limit | limit | limit |
| | TC Reduced | TC Reduced | | | | | |
| | Schedule | Schedule | | | | | |
| 51Q | CFRA- | CFRA- | 1-Jan-21 | no | no | no | no |
| | Reduced | Reduced | | limit | limit | limit | limit |
| | Schedule- | Schedule- | | | | | |
| | Concurrent | Concurrent | | | | | |
| | w/FMLA | w/FMLA | | | | | |
| 51R | PDL- | PDL- | 1-Jan-21 | no | no | no | no |
| | Reduced | Reduced | | limit | limit | limit | limit |
| | Schedule- | Schedule- | | | | | |
| | Concurrent | Concurrent | | | | | |
| | w/FMLA | w/FMLA | | | | | |
| 51S | CFRA- | CFRA- | 1-Jan-21 | no | no | no | no |
| | Reduced | Reduced | | limit | limit | limit | limit |
| | Schedule- | Schedule- | | | | | |
| | Only | Only | | | | | |
| 51T | PDL- | PDL- | 1-Jan-21 | no | no | no | no |
| | Reduced | Reduced | | limit | limit | limit | limit |
| | Schedule- | Schedule- | | | | | |
| | Only | Only | | | | | |
| 51W | State- | State- | 1-Jan-21 | no | no | no | no |
| | Reduced | Reduced | | limit | limit | limit | limit |
| | Schedule- | Schedule- | | | | | |
| | Continuation | Continuation | | | | | |
| 51Y | State- | State- | 1-Jan-21 | no | no | no | no |
| | Reduced | Reduced | | limit | limit | limit | limit |
| | Schedule- | Schedule- | | | | | |
| | Non | Non | | | | | |
| | Continuation | Continuation | | | | | |
| 51U | State Only- | State Only- | 1-Jan-21 | no | no | no | no |
| | Continuation | Continuation | | limit | limit | limit | limit |
| 51V | State | State | 1-Jan-21 | no | no | no | no |
| | Concurrent | Concurrent | | limit | limit | limit | limit |
| | w/FMLA- | w/FMLA- | | | | | |
| | Continuation | Continuation | | | | | |
| 51A | FMLA- | FMLA- | 1-Jan-21 | no | no | no | no |
| | Birth/Adoption | Birth/Adoption | | limit | limit | limit | limit |
| 51B | FMLA- | FMLA- | 1-Jan-21 | no | no | no | no |
| | Medical | Medical | | limit | limit | limit | limit |
| 51C | FMLA- | FMLA- | 1-Jan-21 | no | no | no | no |
| | Family Care | Family Care | | limit | limit | limit | limit |
| 51D | FMLA-Work | FMLA-Work | 1-Jan-21 | no | no | no | no |
| | Comp | Comp | | limit | limit | limit | limit |
| 51G | FMLA- | FMLA- | 1-Jan-21 | no | no | no | no |
| | Military | Military | | limit | limit | limit | limit |
| | Qualifying | Qualifying | | | | | |
| | Exigency | Exigency | | | | | |
| 51M | FMLA- | FMLA- | 1-Jan-21 | no | no | no | no |
| | CFRA | CFRA | | limit | limit | limit | limit |
| 51N | FMLA-PDL | FMLA-PDL | 1-Jan-21 | no | no | no | no |
| | | | | limit | limit | limit | limit |
| 52A | NON | NON | 1-Jan-21 | no | no | no | no |
| | FMLA- | FMLA- | | limit | limit | limit | limit |
| | Birth/Adopt | Birth/Adopt | | | | | |
| 52B | NON | NON | 1-Jan-21 | no | no | no | no |
| | FMLA- | FMLA- | | limit | limit | limit | limit |
| | Medical | Medical | | | | | |
| 52C | NON | NON | 1-Jan-21 | no | no | no | no |
| | FMLA-Work | FMLA-Work | | limit | limit | limit | limit |
| | Comp | Comp | | | | | |
| 51O | CFRA Only | CFRA Only | 1-Jan-21 | no | no | no | no |
| | | | | limit | limit | limit | limit |
| 51P | PDL Only | PDL Only | 1-Jan-21 | no | no | no | no |
| | | | | limit | limit | limit | limit |
| 51L | FMLA- | FMLA- | 1-Jan-21 | no | no | no | no |
| | Military | Military | | limit | limit | limit | limit |
| | Family Care | Family Care | | | | | |
| 52E | NON | NON | 1-Jan-21 | Other | 0 | no | no |
| | FMLA- | FMLA- | | | | limit | limit |
| | Personal | Personal | | | | | |
| 52G | LOA- | LOA- | 1-Jan-21 | no | no | no | no |
| | Military >30 | Military >30 | | limit | limit | limit | limit |
| | days | days | | | | | |
| 51X | State Only- | State Only- | 1-Jan-21 | Other | 0 | no | no |
| | Non | Non | | | | limit | limit |
| | Continuation | Continuation | | | | | |

In a further example, the PTO Processor 410 may also evaluate overrides (e.g., from data entered with the PTO Override form 420). Due to the structure within certain software, some employees may not appear to work in a specific area; however based on their actual job duties, they should be eligible for a plan or program for which the PTO Processor 410 found them ineligible. If an employee's Time Off Plans are overridden, the PTO Processor 410 will ignore the normal PTO eligibility rules form 430 and instead use what is input to the PTO Override form 420 for this employee. In an example, if an employee is found eligible for only the PTO Program, but should also have a City/State sick plan. BOTH plans must be entered in the PTO Override form 420. The PTO Override form 420 may be used to override ALL eligibility. This override is in effect until it is end dated. Overrides can be started or ended in the future. If the Override is effective only for a specific time period, a Future End date should be entered to allow the program to stop using the override logic as of that date. The PTO Processor 410 will look for overrides between the Effective Start date and Effective End date in the PTO override form 420.

In a further example, the PTO Processor 410 may also utilize Element Entries to serve for special rule processing. The PTO Processor 410 may generate the following element entries on the employee's record, for example:

PTO: PTO_Personal Holiday Adjustment—used to clear any remaining balance prior to granting new amount (element is also used to manually adjust balance) using Input Values of Hours. Reason and PTO_Personal Holiday Accrued—shows amount of PTO received during grant, using Input Values of Hours, Status, Threshold, where Threshold is populated with eligible Rule Name from Rule Configuration form.

Vacation: PTO_Vacation Adjustment—used to adjust the PTO_Vacation_Balance due to Max Balance, Max Accrual or Max Carryover (element is also used to manually adjust balance) using Input Values of Hours. Reason and PTO_Vacation Accrued—used for weekly Accrual, Max Balance and Max Accrual using Input Values of Hours, Status, Threshold, Normal Hours, Normal Threshold, where Threshold is populated with eligible Rule Name from Rule Configuration form.

Absence: PTO_Absence Adjustment—used to clear any remaining balance prior to granting new amount (element is also used to manually adjust balance) using Input Values of Hours. Reason and PTO_Absence Accrued—Used for weekly Accrual, Max Balance and Max Accrual using Input Values of Hours. Status, Threshold where Threshold is populated with eligible Rule Name from Rule Configuration form.

As a result of the PTO processor 410 evaluation, various plan assignments and balances may be generated, such as a PTO EIT 480. The PTO EIT may be further adjusted based on an evaluation of a full time anniversary date extension 460 (determined from a full time anniversary date), or a balance program 470 (determined from respective balances). Further other types of human resource scheduling data values may be evaluated and considered.

FIG. 10 illustrates a PTO eligibility flowchart showing a technique 510 for determining an employee PTO grant plan, including the evaluation of various eligibility changes. The PTO processor 410 will consider eligibility based on rules, such as rules set up in the PTO Program Definitions custom form. In an example, to invoke entrance criteria for the PTO Program an employee must be found eligible by the processor for at least one rule and rule criteria, or have an override in the PTO Override form that assigns the employee to a rule. If the criteria from the employee's HR record changes and the employee are no longer found eligible for this program, the PTO processor 410 will invoke Exit logic.

In one example, shown below in Table 3, the employee entry and exit logic used for determining eligibility changes is as follows:

TABLE 3

| | | PTO |
|---|---|---|
| Entrance | Balance | If PTO balance |
| Criteria | | exists |
| | | > Clear |
| | | No action for other |
| | | balances |
| | Grant/Accrual | If FT Anniversary |
| | | > Full Grant |
| | | If not FT |
| | | Anniversary |
| | | > Prorated Grant |
| Exit Criteria | Balance | Retain Balance |

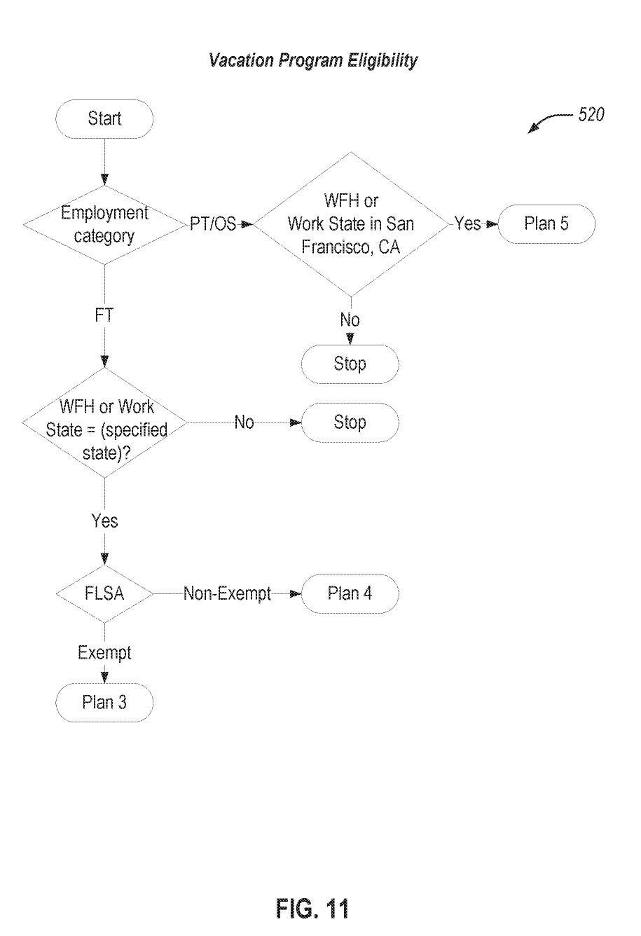

FIG. 11 illustrates a vacation program eligibility flowchart showing a technique 520 including operations for determining eligibility if an employee works or lives in certain specified states that have their own requirements, according to one example. The state-based (or city-based) requirements may usurp company-based programs.

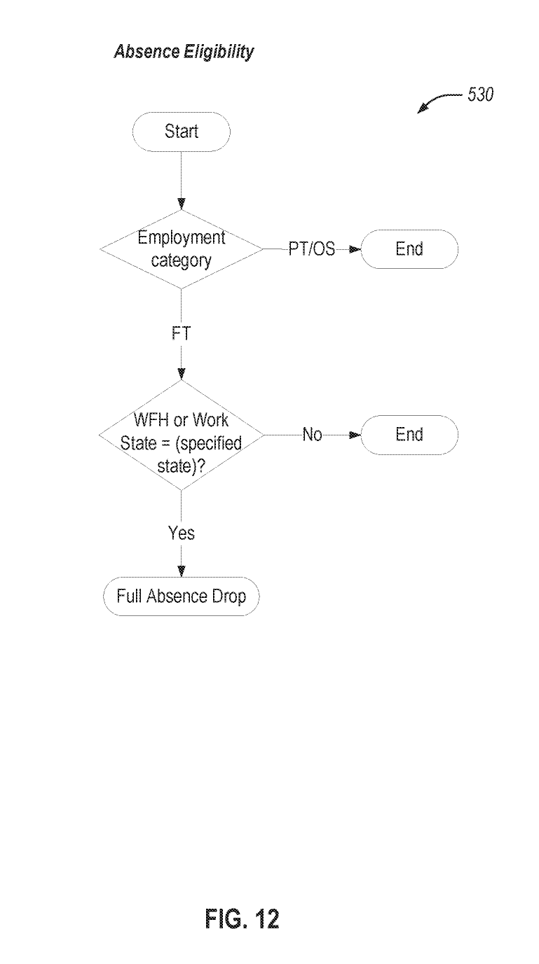

FIG. 12 illustrates an absence eligibility flowchart showing a technique 530 according to one example, which may be relevant if an employee resides or works in certain specified states or cities (or has a work from home (WFH) status). For example, the evaluation of city/state sick plans may be performed. Several cities or states within the U.S. have special laws that specify how much paid sick time employees who work in those locations receive and when they can use it. Each city/state determines the amount of sick time accrued or granted. Upon termination, sick time is currently not paid out for any city/state sick plan.

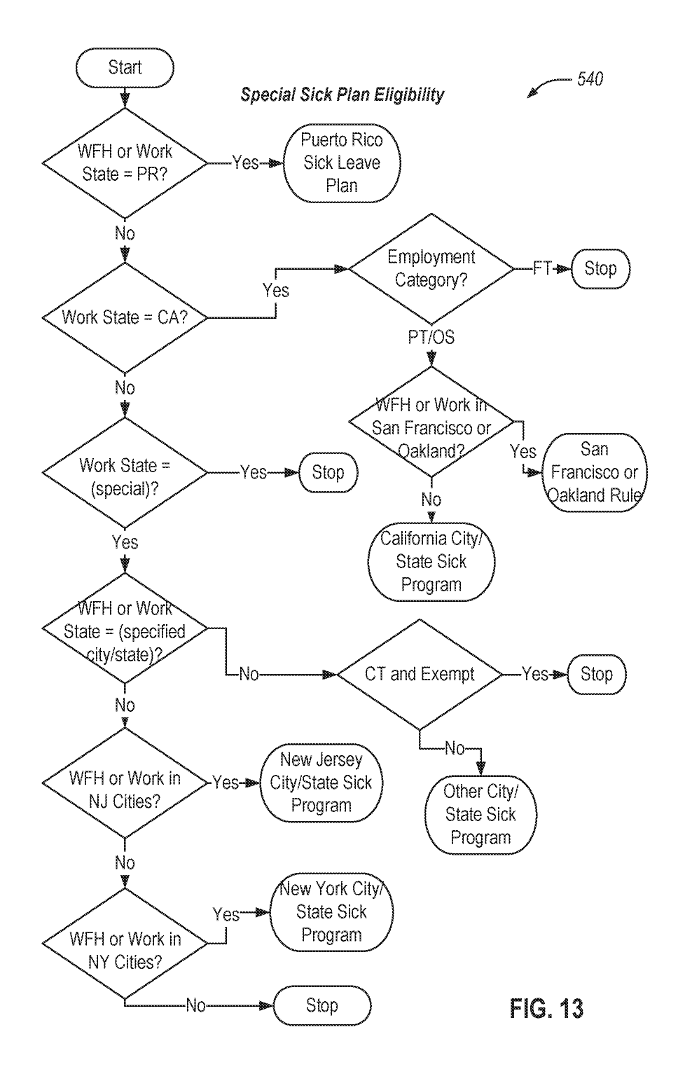

FIG. 13 illustrates an overall flowchart showing a technique 540 for determining employee eligibility for special sick plans, according to one example. For example, the flowchart may be used for special sick plans defined for certain specified cities, states, or other locations (e.g., California, New Jersey, New York, San Francisco, etc.).

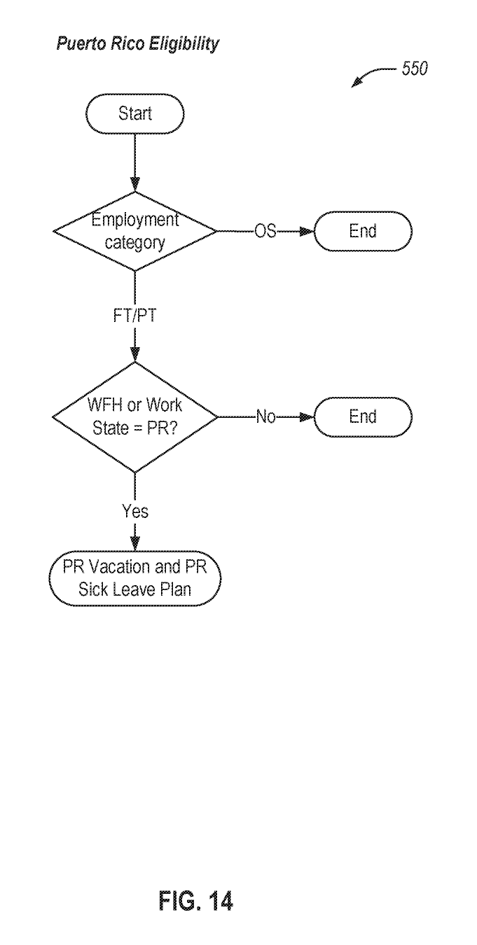

FIG. 14 illustrates a flowchart showing a technique 550 for determining if an employee qualifies for eligibility under Puerto Rico laws, according to one example. Under a Puerto Rico Vacation Plan, Fulltime and Part-time employees who work in Puerto Rico are eligible to receive 10 hours of Vacation time each month if they work a minimum of 115 hours during that month. Exempt employees must work 15 or more days in a month to receive the accrual. Under a Puerto Rick Sick Leave Plan, employees who live or work in Puerto Rico are eligible to receive 10 hours of sick leave each month if they work a minimum of 115 hours during that month. Exempt employees must work 15 or more days in a month to receive the accrual.

In a further example, the graphical user interface and human resources scheduling processing system may include functionality for the following:

PTO Processor Report: The PTO Processor details may be reported in a log that is exportable in a field or report. Details that are processed in the child processes operated by the PTO processor may be included in the main PTO processor report (e.g., generated by PTO Processor 410).

Summary of records processed: Total number of records processed by Phase in the PTO Processor including Records Staged, Eligibility/Ineligibility, Accrual Calculations, and Element Entries, and Total number of records in error. This may include detailed error records, such that System Error or Technical Error may be reported in the Concurrent Log for the Support team to review and Employee level errors will be reported in the Concurrent log for a Benefits team to review and make adjustments as needed. Any employee found eligible for more than one rule within a Plan Type should error out of process and details written to this report.

PTO Requests: When PTO is requested for an employee through the Time and Attendance system or is entered by Payroll, it will be loaded into ‘PTO Request’ information elements. For example, when the elements are processed by a payroll department, a Fast Formula may be executed to check whether the requested hours are available in an employee's balance. If the requested hours exceed the employee's available balance, they will only be paid for the number of hours they have available (ending balance will be zero once the payroll process completes). Otherwise, the employee will be paid for their requested hours. The fast formula will create two indirect results.

The Fast Formula will create PTO Paid earnings elements as an indirect result: PTO Hourly and PTO Salaried. If the employee is hourly as of the Pay Period Begin Date or if the employee is salaried with a Time Card Required flag=Yes, the hours to be paid will be loaded to the PTO Hourly element; if the employee is salaried with a Time Card Required flag=No, they will be loaded to the PTO Salaried element. Both elements will be processed by Payroll, but only the element with the non-zero Hours amount will be paid. The employee's balance will be decreased by the number of hours paid. The PTO Paid elements will not be visible through the Element Entries screens, but can be viewed through the employee's statement of earnings or assignment process results.

Manually Entered Adjustments: Manually entered PTO Adjustments may be entered into the adjustment element by the Benefits team. The adjustment may be entered as either positive or negative hours. The adjustments may not be processed until the regular payroll run or a quick pay is processed for the employee. However, when the PTO Balance Calculation program is run, it may retrieve the employee's current PTO balance from the payroll balance, and add in any ‘Unprocessed’ accrual, adjustment or request elements for the employee that exist by using the next check date.

Commission Rules: Different rules for commission based employees may be used.

Termination: The clearing of balances on termination are handled by a fast formula to pay out PTO or Vacation balances on termination.

Errors: An error flag may be raised if an employee is eligible for more than one rule or program.

Other variations to the above-described rules may be implemented.

Although many of the examples above were described with reference to PTO processes and rules, it will be apparent that the definition, evaluation, simulation, and implement of the presently described techniques for PTO rules are equally applicable to other types of human resource scheduling, including sick time, absence time, vacation time, benefits accrual, and like HR-based scheduling.

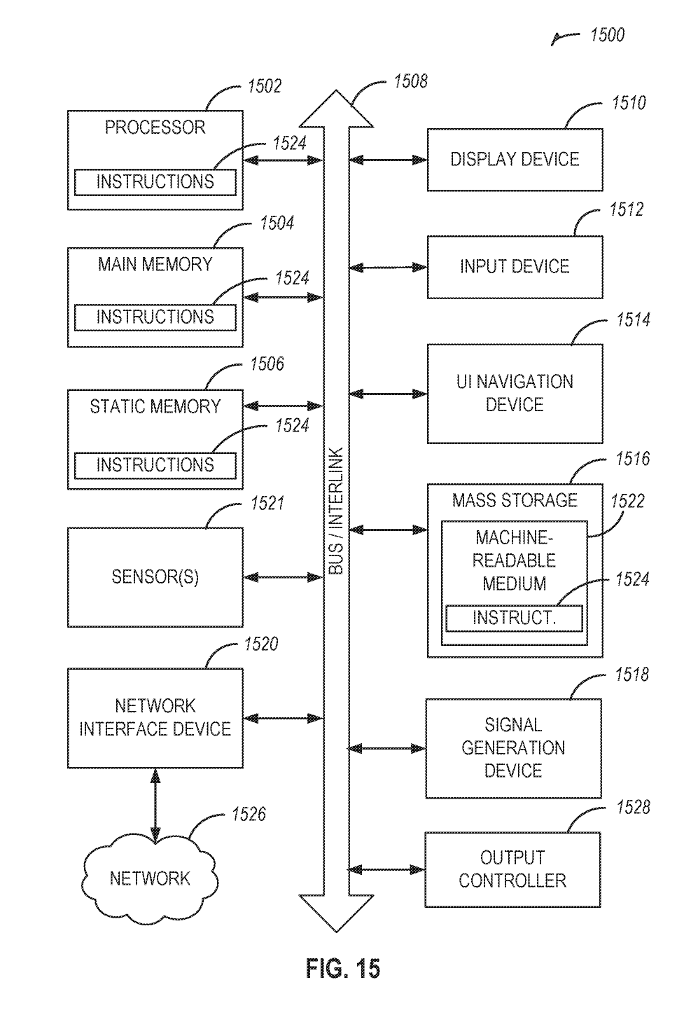

FIG. 15 illustrates generally an example of a block diagram of a machine 1500 upon which any one or more of the techniques discussed herein may perform in accordance with some embodiments. In alternative embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environment. The machine 1500 may be a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Such components are tangible entities (e.g., hardware) capable of performing specified operations when operating. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one component. For example, under operation, the execution units may be configured by a first set of instructions to implement a first component at one point in time and reconfigured by a second set of instructions to implement a second component.

Machine (e.g., computer system) 1500 may include a hardware processor 1502 (e.g., a central processing unit (CPU), a graphics processing unit (GPU), a hardware processor core, or any combination thereof), a main memory 1504 and a static memory 1506, some or all of which may communicate with each other via an interlink (e.g., bus) 1508. The machine 1500 may further include a display unit 1510, an alphanumeric input device 1512 (e.g., a keyboard), and a user interface (UI) navigation device 1514 (e.g., a mouse). In an example, the display unit 1510, alphanumeric input device 1512 and UI navigation device 1514 may be a touch screen display. The machine 1500 may additionally include a storage device (e.g., drive unit) 1516, a signal generation device 1518 (e.g., a speaker), a network interface device 1520, and one or more sensors 1521, such as a global positioning system (GPS) sensor, compass, accelerometer, or other sensor. The machine 1500 may include an output controller 1528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1516 may include a machine readable medium 1522 that is non-transitory on which is stored one or more sets of data structures or instructions 1524 (e.g., software) embodying or utilized by any one or more of the techniques or functions described herein. The instructions 1524 may also reside, completely or at least partially, within the main memory 1504, within static memory 1506, or within the hardware processor 1502 during execution thereof by the machine 1500. In an example, one or any combination of the hardware processor 1502, the main memory 1504, the static memory 1506, or the storage device 1516 may constitute machine readable media.

While the machine readable medium 1522 is illustrated as a single medium, the term “machine readable medium” may include a single medium or multiple media (e.g., a centralized or distributed database, and/or associated caches and servers) configured to store the one or more instructions 1524.

The term “machine readable medium” may include any medium that is capable of storing, encoding, or carrying instructions for execution by the machine 1500 and that cause the machine 1500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device 1520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., local area networks implementing the Institute of Electrical and Electronics Engineers (IEEE) 802.11 family of standards known as Wi-Fi®, personal area networks implementing the Bluetooth specifications promulgated by the Bluetooth Special Interest Group), peer-to-peer (P2P) networks, among others. In an example, the network interface device 1520 may include one or more physical jacks (e.g., Ethernet, coaxial, or phone jacks) or one or more antennas to connect to the communications network 1526. In an example, the network interface device 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1500, and includes digital or analog communications signals or other intangible medium to facilitate communication of such software.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for managing employee paid time off with features in a graphical user interface, according to configurable rules and programs, the method comprising:
using a processor in communication with a database to perform electronic operations that:
receive a change to a paid time off eligibility rule, the paid time off eligibility rule stored in the database;
query the database to determine identifying information for an employee, the identifying information including the paid time off eligibility rule applicable to the employee;
determine, based on the identifying information and the change to the paid time off eligibility rule, a paid time off plan applicable to the employee from a set of paid time off plans with paid time off eligibility rules;
determine an accrual value for the employee using the paid time off plan applicable to the employee; and
output the accrual value in the graphical user interface.

2. The method of claim 1, wherein the accrual value represents an amount of paid time off applied to an employee account, the amount of paid time off including sick time, vacation time, or absence time.

3. The method of claim 1, further comprising using the processor to perform electronic operations that store the accrual value and the paid time off plan applicable to the employee in the database in a location in the database corresponding to an employee record for the employee.

4. The method of claim 1, wherein the paid time off eligibility rule is a government-regulated rule and wherein the change includes a change to the government-regulated rule.

5. The method of claim 1, wherein the electronic operations that determine the paid time off plan include operations that:
determine whether the change to the paid time off rule would cause the employee to be moved to a second paid time off plan;
determine that the second paid time off plan is overridden for the employee by a government-regulated paid time off rule; and
determine that the paid time off plan is a government-regulated paid time off plan.

6. The method of claim 1, wherein the electronic operations that output the accrual value in the graphical user interface include operations that output the accrual value within a simulation generated for output the graphical user interface, without changing the paid time off plan applicable to the employee in the database.

7. The method of claim 1, wherein the electronic operations that output the accrual value in the graphical user interface include operations that:
output, in the graphical user interface, at least two accrual values after determining that the employee is eligible for at least two paid time off plans; and
output, in the graphical user interface, an error message indicating that the employee is eligible for the at least two paid time off plans.

8. The method of claim 7, wherein the electronic operations that output the accrual value in the graphical user interface include operations that: present a selectable indication for selecting one of the at least two paid time off plans to apply to the employee.

9. The method of claim 1, wherein the electronic operations that output the accrual value include operations that output a daily, weekly, or monthly accrual value.

10. The method of claim 1, wherein the identifying information for the employee includes an employee work location or an employee home location, and wherein the electronic operations that determine the paid time off plan applicable to the employee include operations that use the employee work location or the employee home location to determine whether a government-regulated rule changes the accrual value for the employee.

11. A system for managing employee paid time off, according to configurable rules and programs, in a graphical user interface, the system comprising:
a graphical user interface to:
receive a change to a paid time off eligibility rule, the paid time off eligibility rule stored in a database;
display database query results identifying information for an employee, the identifying information including the paid time off eligibility rule applicable to the employee;
receive an accrual value for the employee determined using a paid time off plan applicable to the employee, the paid time off plan determined based on the identifying information and the change to the paid time off eligibility rules from a set of paid time off plans with paid time off eligibility rules; and
display the accrual value.

12. The system of claim 11, wherein the graphical user interface is further to:
display at least two accrual values after determining that the employee is eligible for at least two paid time off plans; and
display an error message indicating that the employee is eligible for the at least two paid time off plans.

13. The system of claim 11, wherein the paid time off eligibility rule is a government-regulated rule and the change includes a change to the government-regulated rule.

14. The system of claim 11, wherein the accrual value represents an amount of time off applied to an employee account, the amount of time off including sick time, vacation time, or leave of absence time.

15. The system of claim 11, wherein to display the accrual value, the graphical user interface is to display the accrual value on a simulation, without changing the paid time off plan applicable to the employee in the database.

16. At least one machine-readable medium including instructions for receiving information, which when executed by a machine, cause the machine to perform electronic operations that:
receive a change to a paid time off eligibility rule, the paid time off eligibility rule stored in a database;
query the database to determine identifying information for an employee, the identifying information including the paid time off eligibility rule applicable to the employee;
determine, based on the identifying information and the change to the paid time off eligibility rule, a paid time off plan applicable to the employee from a set of paid time off plans with paid time off eligibility rules;
determine an accrual value for the employee using the paid time off plan applicable to the employee; and
output the accrual value on a graphical user interface.

17. The at least one machine-readable medium of claim 16, further comprising instructions to store the accrual value and the paid time off plan applicable to the employee in the database in a location in the database corresponding to an employee record for the employee.

18. The at least one machine-readable medium of claim 16, wherein the paid time off eligibility rule is a government-regulated rule and the change includes a change to the government-regulated rule.

19. The at least one machine-readable medium of claim 16, wherein the instructions to determine the paid time off plan include instructions to:
determine that the change to the paid time off rule would cause the employee to be moved to a second paid time off plan;
determine that the second paid time off plan is overridden for the employee by a government-regulated paid time off rule; and
determine that the paid time off plan is a government-regulated paid time off plan.

20. The at least one machine-readable medium of claim 16, wherein the instructions to output the accrual value on the graphical user interface include instructions to output the accrual value on a simulation run on the graphical user interface, without changing the paid time off plan applicable to the employee in the database.
